(19) United States
(12) Patent Application Publication
(10) Pub. No.: US 2016/0056661 A1
(43) Pub. Date: Feb. 25, 2016

(54) CONTACTLESS CHARGING DEVICE, DEVICE TO BE CHARGED, VEHICLE EQUIPPED WITH CONTACTLESS CHARGING DEVICE AND PROGRAM

(71) Applicant: PANASONIC INTELLECTUAL PROPERTY MANAGEMENT CO., LTD., Osaka-shi, Osaka (JP)

(72) Inventor: Hisao TANAKA, Kanagawa (JP)

(21) Appl. No.: 14/780,597

(22) PCT Filed: Mar. 28, 2014
(86) PCT No.: PCT/JP2014/001845

§ 371 Date: Sep. 28, 2015

(30) Foreign Application Priority Data
Mar. 29, 2013 (JP) 2013-071694
Apr. 1, 2013 (JP) 2013-075929
Apr. 1, 2013 (JP) 2013-075930
Apr. 1, 2013 (JP) 2013-075932

(51) Int. Cl. H02J 7/02

(52) U.S. Cl. CPC H02J 7/025

(57) ABSTRACT

A contactless charging device, a device to be charged, a vehicle equipped with the contactless charging device and a program are provided to improve detection accuracy of a conductive foreign object and enhance safety. The contactless charging device has a structure including a charging coil for generating magnetic flux when power is supplied thereto; and a charge controller for detecting a conductive foreign object using the conductivity information for the power reception coil based on the coil information representing the characteristics of the power reception coil in a device to be charged.

### TECHNICAL FIELD

The present invention relates to a contactless charging apparatus, a device to be charged (hereinafter, referred to as “charge-target device”), a vehicle including the contactless charging apparatus, and a program.

### BACKGROUND ART

Mobile terminals such as mobile phones have become extremely advanced in terms of their functions, which leads to large power consumption. Therefore, a demand for making charging available at various locations including the interior of an automobile has been increasing. Further, as a recent trend, so-called contactless charging has drawn attention, in which charging is performed without using a cable.

Known examples of apparatuses for such contactless charging include a technique which includes: a primary coil that charges a mobile terminal; and a charging control section that controls the electric conduction of the primary coil, in which the charging control section performs contactless (non-contact) charging of the mobile terminal while a secondary coil of the mobile terminal receives power due to the magnetic flux from the primary coil (see, e.g., PTL 1).

Further, a specific standard for enabling charging of various types of mobile terminals (such as, e.g., Qi standard) is determined, and a technique is also proposed in which charging is performed when both the contactless charging apparatus and the charge-target device (mobile terminal) comply with the specific standard.

### CITATION LIST

### Patent Literature

### PTL 1

### Japanese Patent Application Laid-Open No. 2010-104203

### SUMMARY OF INVENTION

### Technical Problem

The above-mentioned contactless charging apparatuses are designed to charge, via a standard charging process (charging process compliant with a specific standard), even new mobile terminals introduced into the market one after another, when the apparatuses confirm that the terminals comply with the specific standard.

Here, the standard charging process will be described briefly. When a contactless charging apparatus detects a secondary coil on a mobile terminal side and thus becomes communicable with the mobile terminal, it obtains a battery product number (manufacturer ID of the battery) as well as a battery ID from the mobile terminal. This enables the contactless charging apparatus to identify the mobile terminal as a mobile terminal compliant with the specific standard.

Next, the contactless charging apparatus starts charging with less power supply. Then, the mobile terminal transmits periodically a packet as to whether the power supply is sufficient or insufficient to the contactless charging apparatus. The contactless charging apparatus varies the power supply in accordance with excess or shortage of the amount of the power supply. When the contactless charging apparatus cannot obtain the packet for a predetermined time (e.g., 1.5 seconds), and when it obtains a packet to stop charging from the mobile terminal, the contactless charging apparatus stops charging.

During such a standard charging process, the contactless charging apparatus detects a conductive foreign object between the coils, for example, from the power difference between the transmitted power on the contactless charging apparatus side and the received power on the mobile terminal side. However, the specific standard for enabling charging of various types of mobile terminals is designed to widely support a wide variety of shapes of second coils or characteristics of rechargeable batteries as loads. That is, the power difference undesirably varies for each type of mobile terminal.

Therefore, there is a problem of the contactless charging apparatus not being able to precisely perform the detection processing of a conductive foreign object using the information of electric conduction of the primary coil and the secondary coil, such as the power difference, only from the fact that mobile terminals comply with the specific standard.

An object of the present invention is to provide a contactless charging apparatus, a charge-target device, a vehicle including the contactless charging apparatus, and a program each capable of improving the detection precision of a conductive foreign object to enhance safety.

### Solution to Problem

The contactless charging apparatus according to an embodiment of the present invention is a contactless charging apparatus that charges a charge-target device in a contactless manner, the apparatus including a charging coil that generates a magnetic flux due to power supply, and a charging control section that detects a conductive foreign object from information of electric conduction of a power receiving coil of the charge-target device based on coil information indicating characteristics of the power receiving coil.

A charge-target device according to an embodiment of the present invention includes a power receiving coil that receives power supplied from the contactless charging apparatus, and a communication section that transmits coil information indicating characteristics of the power receiving coil.

### Advantageous Effects of Invention

According to the present invention, it is possible to improve the detection precision of the conductive foreign object to enhance safety.

### BRIEF DESCRIPTION OF DRAWINGS

FIG. 1 is a diagram illustrating a state of a mobile terminal charging apparatus according to an embodiment of the present invention, which is mounted inside an automobile;

FIG. 2 is a perspective view illustrating the appearance of the mobile terminal charging apparatus according to an embodiment of the present invention;

FIG. 3 is a perspective view illustrating how a mobile terminal is placed on the mobile terminal charging apparatus illustrated in FIG. 2;

FIG. 4 is a perspective view illustrating the internal configuration of the mobile terminal charging apparatus illustrated in FIG. 2;

FIG. 5 is a plan view illustrating the internal configuration of the mobile terminal charging apparatus illustrated in FIG. 2;

FIG. 6 is a sectional view illustrating the internal configuration of the mobile terminal charging apparatus illustrated in FIG. 2;

FIG. 7 is a block diagram illustrating the configuration of a contactless charging system according to an embodiment of the present invention;

FIG. 8 is a diagram showing an example of a table of the memory illustrated in FIG. 7;

FIG. 9 is a flowchart showing the operations of a charging control section in the mobile terminal charging apparatus illustrated in FIG. 7; and

FIGS. 10A, 10B, and 10C are diagrams each showing an example of text to be shown on a display.

### DESCRIPTION OF EMBODIMENT

Hereinafter, an embodiment of the present invention will be described in detail with reference to the drawings.

### Embodiment

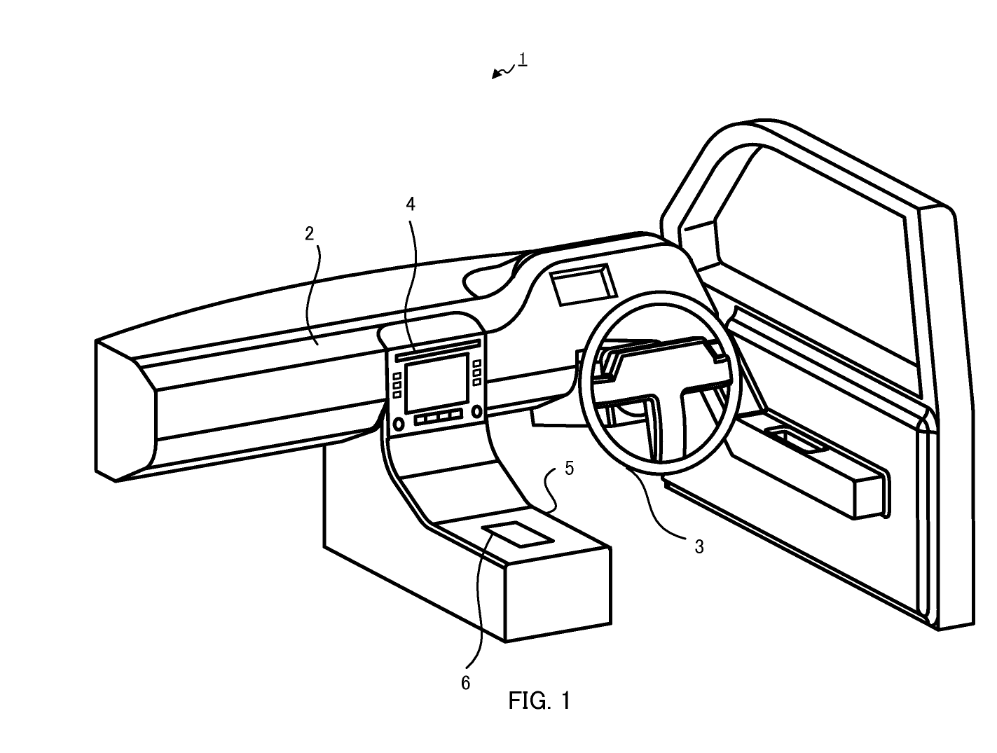

FIG. 1 is a diagram illustrating the state of mobile terminal charging apparatus 6 according to an embodiment of the present invention, which is mounted inside automobile 1.

In FIG. 1, steering wheel 3 is mounted on instrument panel 2 on the driver's seat side in automobile 1.

Electronic device 4, which plays music and video as well as displays car navigation images, is mounted in the vicinity of the center of instrument panel 2.

Further, mobile terminal charging apparatus 6 is mounted in center console 5.

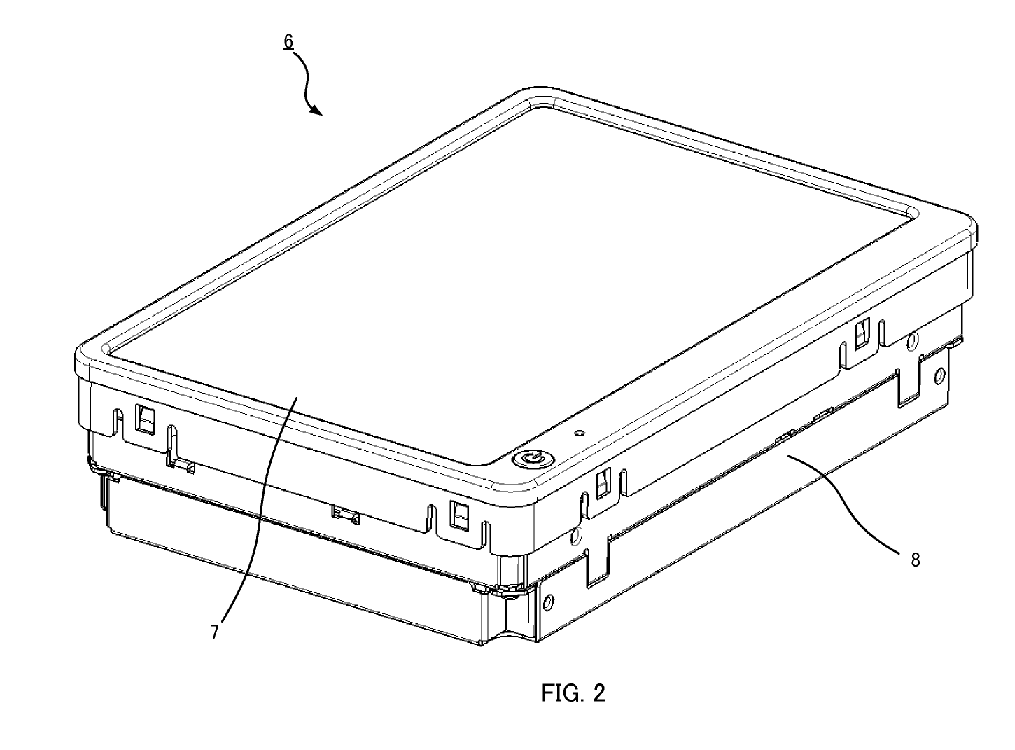

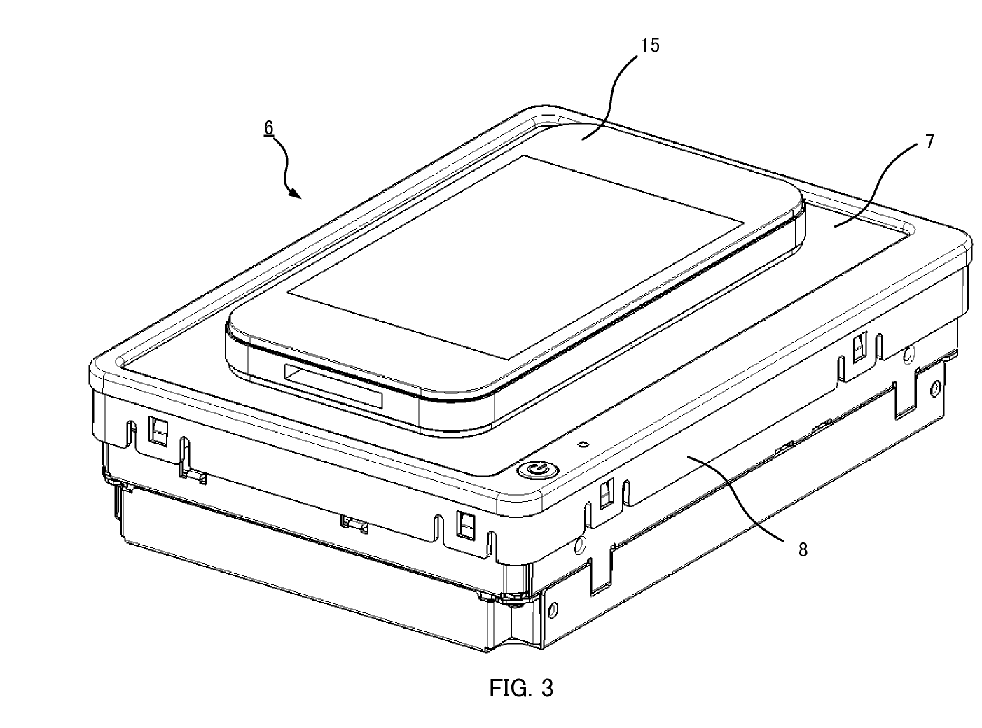

As illustrated in FIGS. 2 to 6, this mobile terminal charging apparatus 6 includes box-shaped main body case 8 having mobile terminal mounting plate 7 being placed on the top surface thereof. In addition, mobile terminal charging apparatus 6 includes, in this main body case 8, charging coil 9 provided movably in a horizontal direction in such a state as to face the under surface side of mobile terminal mounting plate 7, and drive section 10 that moves charging coil 9 in a horizontal direction while causing charging coil 9 to face the under surface side of mobile terminal mounting plate 7.

Hereinafter, each component will be described in detail.

First, mobile terminal mounting plate 7 will be described.

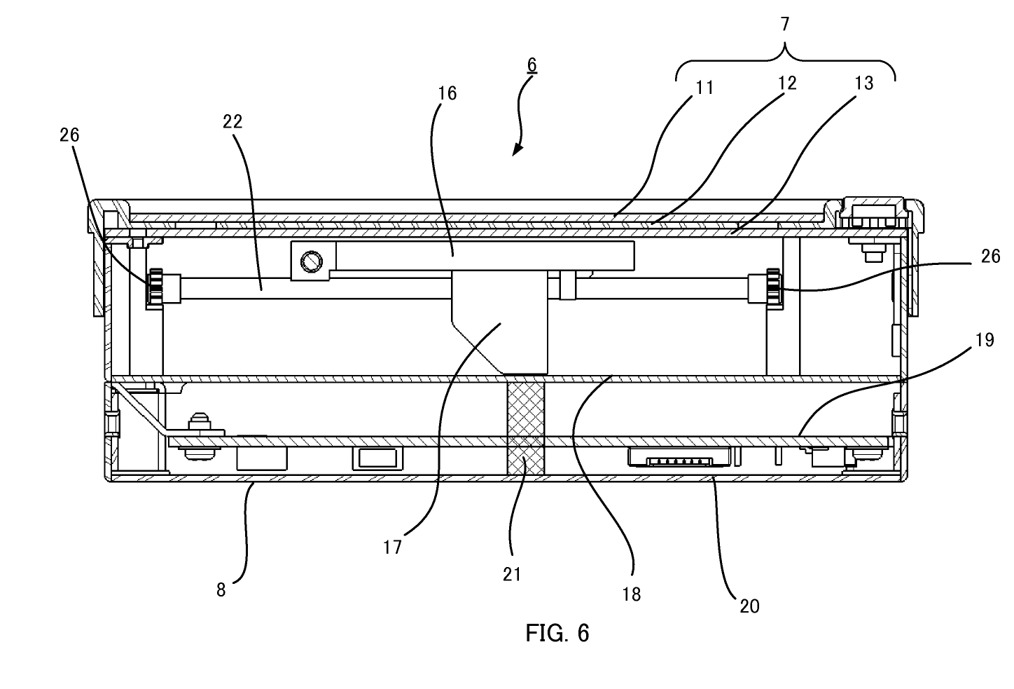

As illustrated in FIG. 6, mobile terminal mounting plate 7 has a configuration in which surface plate 11, middle plate 12, and bottom plate 13 are stacked one on top of another.

Front plate 11 and bottom plate 13 are formed of a synthetic resin, and middle plate 12 is formed of a ceramic material. That is, this configuration allows a magnetic flux from charging coil 9 to pass through toward mobile terminal 15.

Driving section 10 moves charging coil 9 to the position of a power receiving coil (not illustrated) of mobile terminal 15.

Next, the section of charging coil 9 will be described.

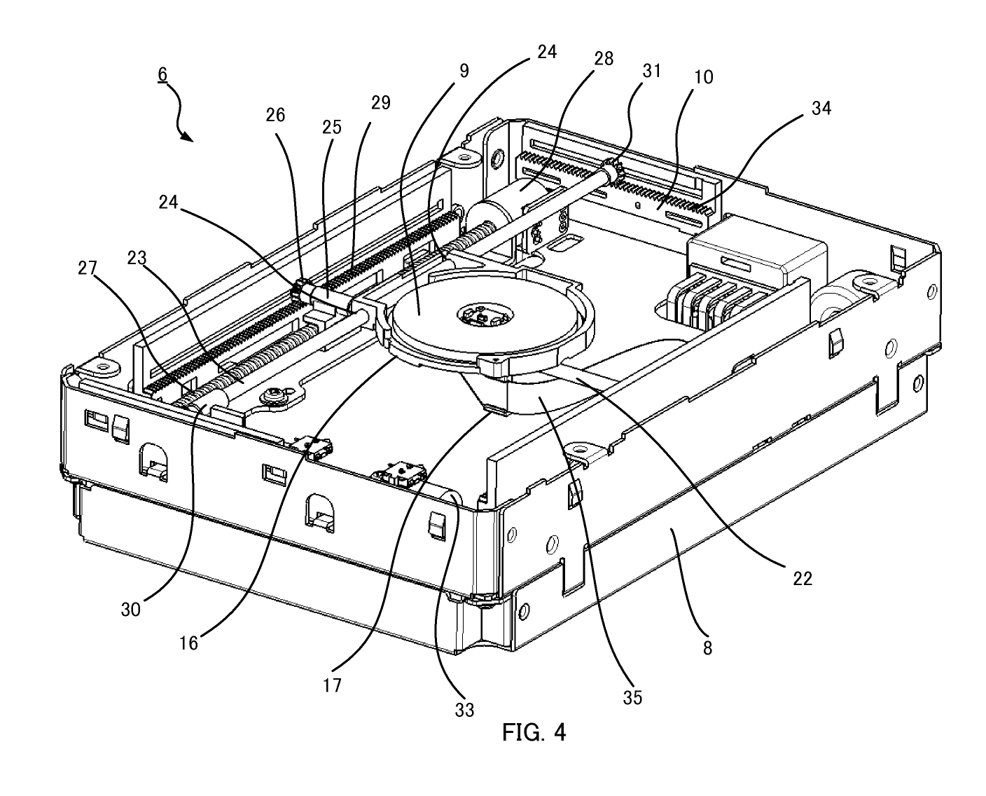

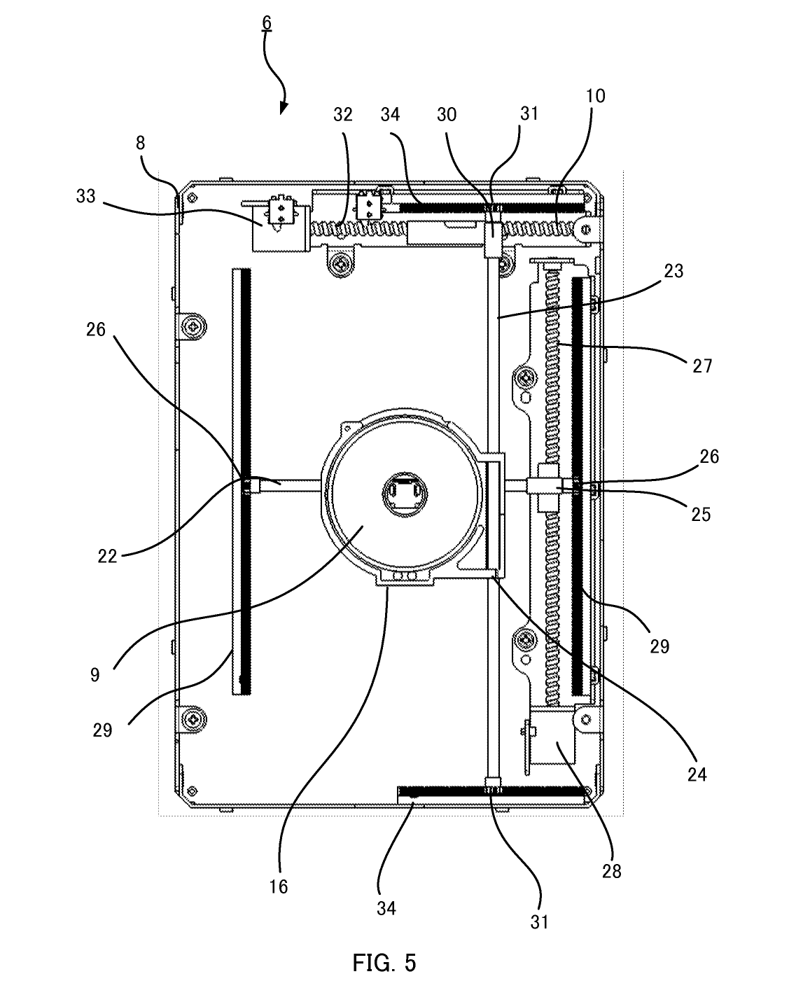

As can be understood from FIGS. 4 and 5, charging coil 9 is configured by winding a lead wire annularly multiple times, and is held with its outer peripheral side and under surface side being covered with holder 16 made of a synthetic resin.

Further, as illustrated in FIG. 6, support leg 17, which extends downward from the above-mentioned charging coil 9, is integrally formed at the under surface of holder 16.

A gap of 0.3 mm is provided between the under surface of support leg 17 and the top surface of support plate 18 made of metal disposed under support leg 17, so that the under surface of support leg 17 does not contact the top surface of support plate 18 during the movement of charging coil 9, in the normal state.

Thus, the present embodiment adopts a configuration in which support leg 17 is provided under charging coil 9.

It is noted that, control substrate 19 and underside plate 20 of main body case 8 are disposed under support plate 18, and that support 21 penetrating control substrate 19 is provided between the under surface of support plate 18 and the top surface of underside plate 20.

Next, drive section 10 will be described.

As illustrated in FIGS. 4 and 5, drive section 10 has X-axis direction drive shaft 22 and Y-axis direction drive shaft 23, and each of middle portions of X-axis direction drive shaft 22 and Y-axis direction drive shaft 23 is engaged with support 16 outside a charging oil holding portion of support 16.

That is, support 16 has a through hole (not illustrated) which X-axis direction drive shaft 22 penetrates and through hole 24 which Y-axis direction drive shaft 23 penetrates being provided in a cross manner, at a predetermined distance away from each other in the vertical direction. X-axis direction drive shaft 22 and Y-axis direction drive shaft 23 penetrate the through holes to be engaged with support 16.

X-axis direction drive shaft 22 has worm wheel 25 being provided on one end side, and gears 26 being provided on one end as well as on the other end. Worm wheel 25 is engaged with worm shaft 27, and worm shaft 27 is coupled to motor 28.

Gears 26 on both sides are respectively engaged with gear plates 29.

Therefore, when motor 28 is driven, worm shaft 27 rotates, thereby allowing worm wheel 25 to move in the X-axis direction together with X-axis direction drive shaft 22. This allows charging coil 9 to move in the X-axis direction.

Further, Y-axis direction drive shaft 23 has worm wheel 30 being provided on one end side, and gears 31 being provided on one end as well as on the other end.

Worm wheel 30 is engaged with worm shaft 32, and worm shaft 32 is coupled to motor 33.

Gears 31 on both sides are respectively engaged with gear plates 34.

Therefore, when motor 33 is driven, worm shaft 32 rotates, thereby allowing worm wheel 30 to move in the Y-axis direction together with Y-axis direction drive shaft 23. This allows charging coil 9 to move in the Y-axis direction.

It is noted that reference sign 35 as shown in FIG. 4 represents flexible wiring for electric conduction to charging coil 9, and the end portion of flexible wiring 35 is fixed to the side surface of the above-mentioned support leg 17.

In the configuration as described above, mobile terminal charging apparatus 6 allows charging coil 9 to move to the center of main body case 8 when an accessory-off signal of the automobile is detected, as illustrated in FIGS. 4 to 6.

Further, as illustrated in FIG. 2, when mobile terminal 15 is not placed on mobile terminal mounting plate 7 of main body case 8, a user may sometimes mistakenly put his or her hand on mobile terminal mounting plate 7. In this case, an excessive load is undesirably applied on mobile terminal mounting plate 7.

To address such a situation, in the present embodiment, as illustrated in FIGS. 4 to 6, charging coil 9 is moved to the center of main body case 8, thereby enabling the above-mentioned excessive load to be supported by charging coil 9, holder 16, support leg 17, and support plate 18.

Thus, when an excessive load is applied onto mobile terminal mounting plate 7, mobile terminal mounting plate 7 curves downward slightly, whereas charging coil 9, holder 16, and support leg 17 also move downward, allowing the under surface of support leg 17 to abut the top surface of support plate 18.

As a result, the above-mentioned excessive load can be sustained by support plate 18 via mobile terminal mounting plate 7, charging coil 9, holder 16 and support leg 17. Thus, mobile terminal mounting plate 7 and charging coil 9 can be prevented from being damaged.

It is noted that, in the present embodiment, the under surface side of support plate 18 is configured to be supported by underside plate 20 of main body case 8 via support 21, in order to enhance the strength against an excessive load.

When such an excessive load is removed, mobile terminal mounting plate 7 elastically returns upward, and charging coil 9 and holder 16 also return upward due to the elastic return of X-axis direction drive shaft 22 and Y-axis direction drive shaft 23, thus allowing the under surface of support leg 17 to be disposed with a gap formed over the top surface of support plate 18, which therefore does not become an obstacle during the subsequent movement of charging coil 9.

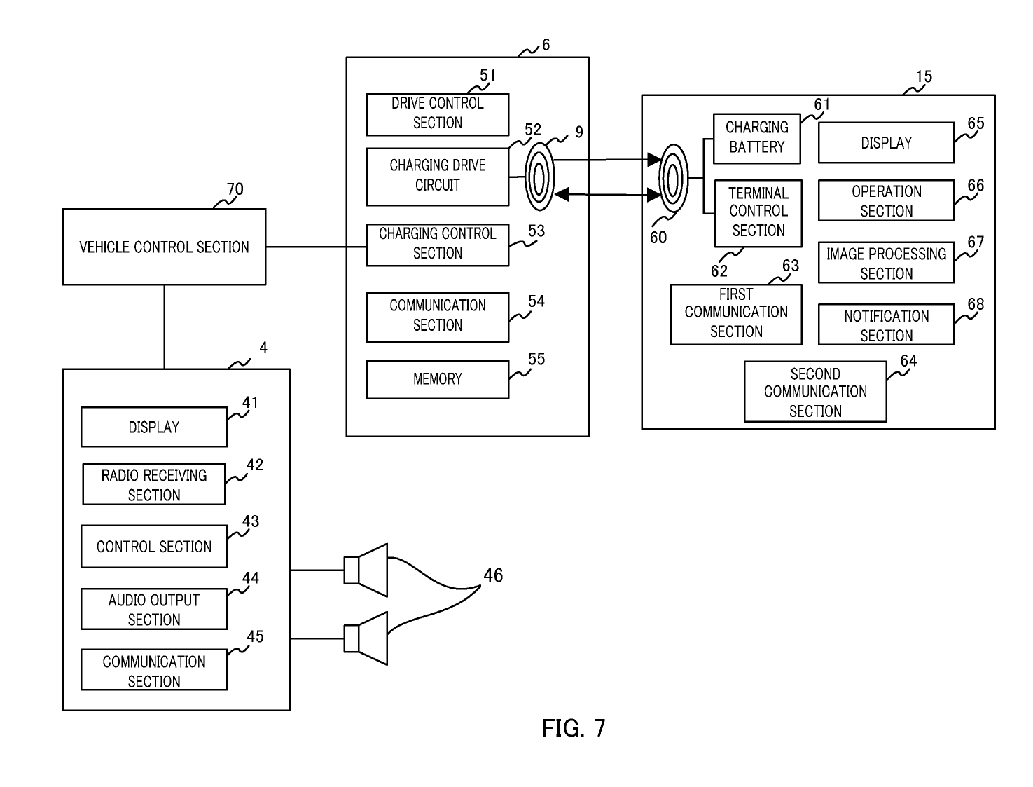

FIG. 7 is a block diagram illustrating the configuration of a contactless charging system according to an embodiment of the present invention. The contactless charging system includes electronic device 4, vehicle control section 70, mobile terminal charging apparatus 6, and mobile terminal 15.

First, electronic device 4 will be described.

Display 41 displays video including car navigation images, and radio receiving section 42 receives and demodulates radio broadcasting waves to output them to audio output section 44. Display 41 may also include a touch panel as an input section.

Control section 43 performs various operations based on a predetermined program to control each component of electronic device 4.

Audio output section 44 amplifies the radio broadcasting signals output from radio receiving section 42, and music signals reproduced by control section 43 to output them to speaker 46.

Communication section 45 performs radio communication with an external device such as mobile terminal 15 using near-field radio communication such as Bluetooth (registered trademark).

Next, mobile terminal charging apparatus 6 will be described.

Motors 28 and 33 are connected to drive control section 51, which controls motors 28 and 33.

Charging drive circuit 52 supplies power to charging coil 9 based on the control of charging control section 53, and charging coil 9 generates a magnetic flux due to the power supplied from charging drive circuit 52.

Charging control section 53 performs various operations based on a predetermined program to control each component of mobile terminal charging apparatus 6.

Communication section 54 performs inter-coil communication using charging coil 9 and power receiving coil 60 of mobile terminal 15 to communicate with mobile terminal 15.

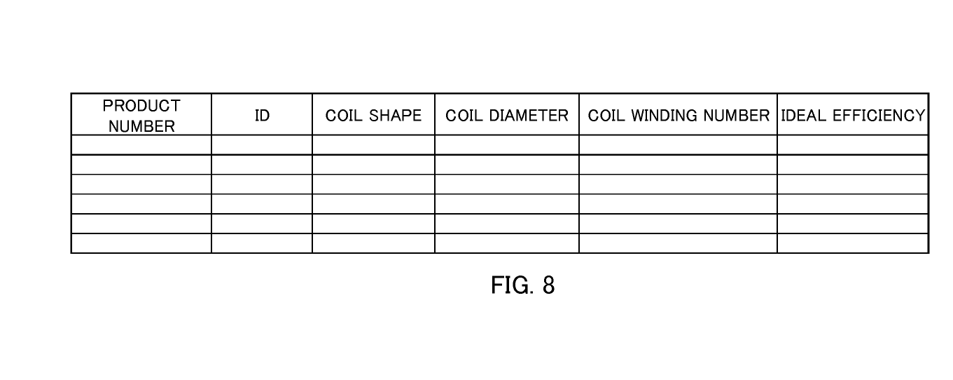

Memory 55 stores a battery product number (corresponding to manufacturer of the battery) and a battery ID (corresponding to production number (serial number) of battery) of mobile terminal 15, coil information (at least one of a coil shape, a coil diameter, and a coil winding number (the number of turns of coil)), an ideal efficiency, and the like. Memory 55 manages such information, for example, as a table as shown in FIG. 8. It is noted that the battery product number and the battery ID constitute the identification information of a battery module of mobile terminal 15.

Next, mobile terminal 15 will be described.

Power receiving coil 60 is configured by winding lead wire annularly multiple times, and generates induced power due to a magnetic flux generated from power receiving coil 9 of mobile terminal charging apparatus 6 to output the induced power to a charging battery as received power.

Charging battery 61 stores power received by power receiving coil 60 to supply the stored power to each component of mobile terminal 15.

Terminal control section 62 performs various operations based on a predetermined program such as an application to control each component of mobile terminal 15.

First communication section 63 performs inter-coil packet communication using power receiving coil 60 and charging coil 9 of mobile terminal charging apparatus 6 to communicate with mobile terminal charging apparatus 6. The packet contains the battery product number and the battery ID.

Second communication section 64 performs radio communication with electronic device 4 by near-field radio communication such as Bluetooth using an application. In the communication using the application, second communication section 46 transmits the coil information of power receiving coil 60 to communication section 45 of electronic device 4.

It is noted that the data to be communicated (battery product number, battery ID, and coil information) may be transmitted either by first communication section 63 or second communication section 64.

Display 65 displays video and text, and operation section 66 receives the operation instruction of a user by means of, for example, a touch panel that enables the user to select a predetermined image area such as an icon displayed on the display, and a physical key.

Image processing section 67 processes input image information with a predetermined algorithm, and causes display 65 to display the information.

Notification section 68 associates predetermined signals with sound, light, vibration, or the like to notify a user of the predetermined signals with sound, light, vibration, or the like.

It is noted that vehicle control section 70 is connected to both electronic device 4 and mobile terminal charging apparatus 6 by Controller Area Network (CAN) bus which is an onboard LAN to control each component of automobile 1, including those of electronic device 4 and mobile terminal charging apparatus 6.

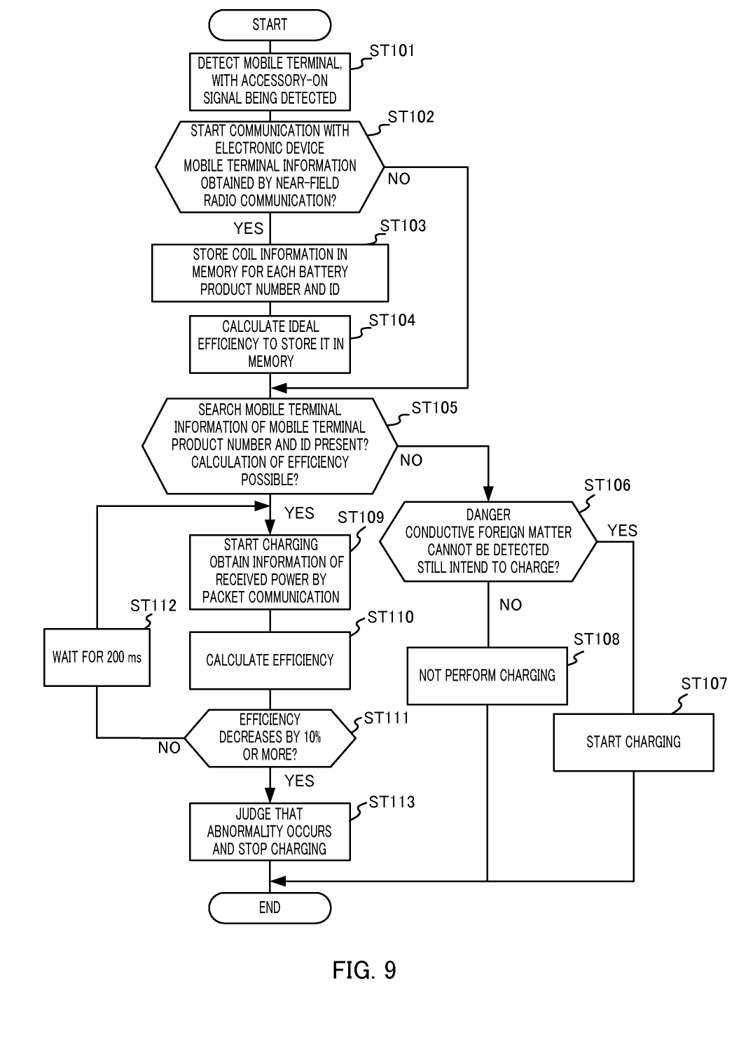

Next, the operations of charging control section 53 in mobile terminal charging apparatus 6 mentioned above will be described using FIG. 9.

In Step (hereinafter, abbreviated as “ST”) 101, charging control section 53 detects mobile terminal 15, with an accessory-on signal being detected.

In ST102, charging control section 53 starts communication with electronic device 4 via vehicle control section 70, and determines whether or not the information of mobile terminal 15 obtained by electronic device 4 using near-field radio communication is obtained from electronic device 4. When the information is obtained (YES), the operation moves to ST103, and when the information is not obtained (NO), the operation moves to ST105.

In ST103, charging control section 53 allows memory 55 to store, out of the obtained information of mobile terminal 15, a battery product number, and, for each ID, the coil information such as a coil shape, a coil diameter, and a coil winding number of the power receiving coil of mobile terminal 15.

In ST104, charging control section 53 calculates a theoretically maximum power supply efficiency (hereinafter, referred to as “an ideal efficiency”) based, for example, on the coil information of charging coil 9, and on the coil information of the power receiving coil of mobile terminal 15 and stores the calculated ideal efficiency in association with the battery product number and the ID in memory 55.

In ST105, charging control section 53 searches mobile terminal 15 to determine whether or not it is possible to calculate the power supply efficiency. This determination is performed according to whether or not the battery product number and the ID of searched mobile terminal 15 are stored in memory 55. When it is possible to calculate the power supply efficiency (YES), the operation moves to ST109, and when it is not possible to calculate the power supply efficiency (NO), the operation moves to ST106.

It is noted that charging control section 53 may also be designed such that a user can input the information of mobile terminal 15 (a battery product number, and, for each ID, a coil shape, a coil diameter, a coil winding number, and the like of the power receiving coil of mobile terminal 15) using electronic device 4, during that time.

For example, control section 43 of electronic device 4 runs an application for inputting the information of mobile terminal 15, so that a user operates the application to input the information with a touch panel of display 41.

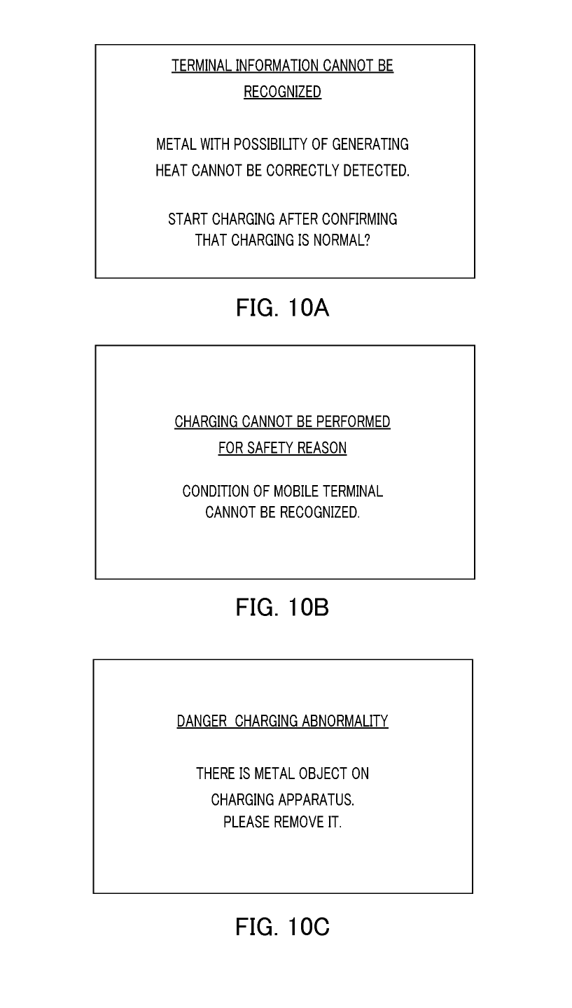

In ST106, charging control section 53 determines that a conductive foreign object cannot be detected correctly, and inquires of a user whether charging is performed even in such a state. During that time, the text screen as shown in FIG. 10A is displayed on display 41 of electronic device 4 and on display 65 of mobile terminal 15, for example. When the user instructs charging to be performed (YES), charging control section 53 starts charging in ST107. On the other hand, when the user does not instruct charging (NO), charging control section 53 does not perform charging in ST108. During that time, for example, the text screen as shown in FIG. 10B is displayed on display 41 of electronic device 4 and on display 65 of mobile terminal 15 to stop the charging.

In ST109, charging control section 53 starts charging, and performs inter-coil communication using charging coil 9 and power receiving coil 60 of mobile terminal 15 to obtain the information of received power in mobile terminal 15.

In ST110, charging control section 53 calculates the power supply efficiency during charging based on the information of received power in mobile terminal 15 and on charged power. In ST111, charging control section 53 determines whether or not the power supply efficiency during charging decreases by 10% or more relative to the ideal efficiency stored in memory 55, and when the efficiency decreases (YES), the operation moves to ST113, and when the efficiency does not decrease (NO), the operation moves to ST112.

In ST112, charging control section 53 waits for 200 ms, and then, the operation returns to ST109.

In ST113, charging control section 53 determines that a conductive foreign object is detected, and causes display 41 of electronic device 4 and display 65 of mobile terminal 15 to display the text screen as shown in FIG. 10C.

It is noted that, the description has been made hereinabove based on the assumption that, when the power supply efficiency during charging decreases by 10% or more relative to the ideal efficiency, it is determined that a conductive foreign object is detected; however, the percentage for the detection of a conductive foreign object is not limited to 10%, and can be appropriately set.

Thus, according to the present embodiment, mobile terminal charging apparatus 6 obtains the coil information of power receiving coil 60 of mobile terminal 15, and calculates the ideal efficiency based on the coil information of power receiving coil 60 to detect a conductive foreign object from the percentage by which the power supply efficiency during the charging of mobile terminal 15 decreases relative to the ideal efficiency. This makes it possible to detect a conductive foreign object precisely despite the charging using different power receiving coils for respective mobile terminals and thus to enhance safety by avoiding heating of the conductive foreign object.

According to the present embodiment, the coil information of power receiving coil 60 of mobile terminal 15 is transmitted by near-field radio communication between mobile terminal 15 and electronic device 4, and by CAN bus which is an onboard LAN between electronic device 4 and mobile terminal charging apparatus 6. This makes it possible to transmit the information of mobile terminal 15 through the existing CAN bus even when mobile terminal charging apparatus 6 does not conform to near-field radio communication.

According to the present embodiment, mobile terminal charging apparatus 6 stores the coil information of power receiving coil 60 of mobile terminal 15 in association with the battery product number and the battery ID. This makes it possible to detect precisely a conductive foreign object even when a mobile terminal of a passenger other than the owner of the automobile is charged, as long as the information of various mobile terminals is stored.

It is noted that, the description has been made in the present embodiment based on the assumption that, the information of mobile terminal 15 is transmitted to electronic device 4 via near-field radio communication, and is transmitted from electronic device 4 to mobile terminal charging apparatus 6 via the CAN bus. However, the present invention is not limited to this embodiment, and mobile terminal 15 and mobile terminal charging apparatus 6 may directly communicate with each other via near-field radio communication.

While the description has been made in the present embodiment of the case where the text screen as shown in FIG. 10A, 10B or 10C is displayed on display 41 of electronic device 4 and on display 65 of mobile terminal 15, notification section 68 may notify the user.

While the description has been made in the present embodiment based on the assumption that the battery product number, ID, coil information, and the ideal efficiency obtained from mobile terminal 15 are stored in memory 55, these pieces of information may be stored in memory 55 in advance.

While the description has been made in the present embodiment of the case where mobile terminal 15 transmits the battery product number and the battery ID from first communication section 63 and the coil information from second communication section 64, the present invention is not limited to this embodiment; the battery product number, the battery ID, and the coil information may be transmitted from either first communication section 63 or second communication section 64. That is, there is no particular limitation on the means for transmitting the information to mobile terminal charging apparatus 6.

Further, while the power supply efficiency is used to detect the conductive foreign object in the present embodiment, it is also possible to detect the conductive foreign object using the information of electric conduction (such as current and power) of power receiving coil 60, as disclosed in a related art literature (e.g., JP 2011-211760, 2011 Oct. 20).

<Outline of Aspects of the Invention>

Next, the outline of an embodiment according to the present invention will be described.

Aspect 1 is a contactless charging apparatus that charges a charge-target device in a contactless manner, the apparatus including a charging coil that generates a magnetic flux due to power supply, and a charging control section that detects a conductive foreign object from information of electric conduction of a power receiving coil of the charge-target device based on coil information indicating characteristics of the power receiving coil.

Aspect 2 is the contactless charging apparatus according to Aspect 1, in which the charging control section detects a conductive foreign object from a percentage by which a power supply efficiency during charging of the charge-target device decreases relative to an ideal efficiency of power supply for the charge-target device.

Aspect 3 is the contactless charging apparatus according to Aspect 2, further including a communication section that obtains, from an electronic device connected to the contactless charging apparatus through an onboard LAN, the coil information transmitted to the electronic device from the charge-target device using radio communication.

Aspect 4 is the contactless charging apparatus according to Aspect 1, further including a communication section that obtains the coil information from an electronic device communicably connected to the contactless charging apparatus, the electronic device allowing the coil information to be input by operation via the electronic device.

Aspect 5 is the contactless charging apparatus according to Aspect 1, in which the coil information includes at least one of a coil shape, a coil diameter, and a coil winding number.

Aspect 6 is a vehicle including the contactless charging apparatus according to any one of Aspects 1 to 4 mounted in the vehicle.

Aspect 7 is a charge-target device, including a power receiving coil that receives power supplied from a contactless charging apparatus, and a communication section that transmits coil information indicating characteristics of the power receiving coil.

Aspect 8 is a program for causing a computer to execute processing comprising: calculating a power supply efficiency during charging of a charge-target device, and detecting a conductive foreign object from a percentage by which the calculated power supply efficiency decreases relative to an ideal efficiency of power supply for the charge-target device based on coil information indicating characteristics of a power receiving coil of the charge-target device.

Aspect 9 is a program for causing a computer to execute processing comprising: obtaining coil information indicating characteristics of a power receiving coil, and transmitting the obtained coil information.

Aspect 10 is a contactless charging apparatus that charges a charge-target device in a contactless manner, the apparatus including a storage section that stores coil information indicating characteristics of a power receiving coil of the charge-target device, and a charging control section that notifies a charge-target device that charging is not possible, the charge-target device being a charge-target device for which the coil information is not stored in the storage section.

Aspect 11 is a contactless charging apparatus that charges a charge-target device in a contactless manner, the apparatus including a storage section that stores coil information indicating characteristics of a power receiving coil of the charge-target device, and a charging control section that performs a control so as not to charge the charge-target device for which the coil information is not stored.

Aspect 12 is a program for causing a computer to execute processing comprising: storing coil information indicating characteristics of a power receiving coil of a charge-target device, and notifying the charge-target device that charging is not possible, the charge-target device being a charge-target device for which the coil information is not stored.

Aspect 13 is a program for causing a computer to execute processing comprising: storing coil information indicating characteristics of a power receiving coil of a charge-target device, and performing a control so as not to charge the charge-target device for which the coil information is not stored.

Aspect 14 is a contactless charging apparatus that charges a charge-target device in a contactless manner, the apparatus including a charging coil that generates a magnetic flux due to power supply, a storage section that stores coil information in association with identification information of a battery module of the charge-target device, the coil information indicating characteristics of a power receiving coil of the charge-target device, and a charging control section that detects a conductive foreign object from a percentage by which a power supply efficiency during charging of the charge-target device decreases relative to an ideal efficiency of power supply for the charge-target device based on the coil information stored in the storage section.

Aspect 15 is the contactless charging apparatus according to Aspect 14, in which the storage section stores in advance the coil information associated with the identification information of the battery module.

Aspect 16 is the contactless charging apparatus according to Aspect 14, further including a communication section that obtains the identification information of the battery module and the coil information from the charge-target device, in which the storage section stores the identification information of the battery module and the coil information obtained by the communication section.

Aspect 17 is a program for causing a computer to execute processing comprising: storing coil information in association with identification information of a battery module of a charge-target device, the coil information indicating characteristics of a power receiving coil of the charge-target device, and detecting a conductive foreign object from a percentage by which a power supply efficiency during charging of the charge-target device decreases relative to an ideal efficiency of power supply for the charge-target device based on the stored coil information.

The disclosures of Japanese Patent Applications No. 2013-071694, filed on Mar. 29, 2013, No. 2013-075929, No. 2013-075930, and No. 2013-075932, filed on Apr. 1, 2013, including the specifications, drawings and abstracts, are incorporated herein by reference in their entireties.

### INDUSTRIAL APPLICABILITY

The contactless charging apparatus, the charge-target device, the vehicle including the contactless charging apparatus, and the program according to the present invention are useful in improving the detection precision of a conductive foreign object to enhance safety.

### REFERENCE SIGNS LIST

1 Automobile
2 Instrument panel
3 Steering wheel
4 Electronic device
5 Center console
6 Mobile terminal charging apparatus
7 Mobile terminal mounting plate
8 Main body case
9 Charging coil
10 Drive section
11 Surface plate
12 Middle plate
13 Bottom plate
15 Mobile terminal
16 Holder
17 Support leg
18 Support plate
19 Control substrate
20 Underside plate
21 Support
22 X-axis direction drive shaft
23 Y-axis direction drive shaft
24 Through hole
25, 30 Worm wheel
26, 31 Gear
27, 32 Worm shaft
28, 33 Motor
29, 34 Gear plate
35 Flexible wiring
41, 65 Display
42 Radio receiving section
43 Control section
44 Audio output section
45, 54 Communication section
46 Speaker
51 Drive control section
52 Charging drive circuit
53 Charging control section
55 Memory
60 Power receiving coil
61 Charging battery
62 Terminal control section
63 First communication section
64 Second communication section
66 Operation section
67 Image processing section
68 Notification section
70 Vehicle control section

1. A contactless charging apparatus that charges a charge-target device in a contactless manner, the apparatus comprising:
a charging coil that generates a magnetic flux due to power supply; and
a charging control section that detects a conductive foreign object from information of electric conduction of a power receiving coil of the charge-target device based on coil information indicating characteristics of the power receiving coil.

2. The contactless charging apparatus according to claim 1, wherein the charging control section detects a conductive foreign object from a percentage by which a power supply efficiency during charging of the charge-target device decreases relative to an ideal efficiency of power supply for the charge-target device.

3. The contactless charging apparatus according to claim 2, further comprising a communication section that obtains, from an electronic device connected to the contactless charging apparatus through an onboard LAN, the coil information transmitted to the electronic device from the charge-target device using radio communication.

4. The contactless charging apparatus according to claim 1, further comprising a communication section that obtains the coil information from an electronic device communicably connected to the contactless charging apparatus, the electronic device allowing the coil information to be input by operation via the electronic device.

5. The contactless charging apparatus according to claim 1, wherein the coil information includes at least one of a coil shape, a coil diameter, and a coil winding number.

6. A vehicle comprising the contactless charging apparatus according to claim 1 mounted in the vehicle.

7. A charge-target device, comprising:
a power receiving coil that receives power supplied from a contactless charging apparatus; and
a communication section that transmits coil information indicating characteristics of the power receiving coil.

8-9. (canceled)

10. A contactless charging apparatus that charges a charge-target device in a contactless manner, the apparatus comprising:
a storage section that stores coil information indicating characteristics of a power receiving coil of the charge-target device; and
a charging control section that notifies a charge-target device that charging is not possible, the charge-target device being a charge-target device for which the coil information is not stored in the storage section.

11. A contactless charging apparatus that charges a charge-target device in a contactless manner, the apparatus comprising:
a storage section that stores coil information indicating characteristics of a power receiving coil of the charge-target device; and
a charging control section that performs a control so as not to charge the charge-target device for which the coil information is not stored.

12-13. (canceled)

14. A contactless charging apparatus that charges a charge-target device in a contactless manner, the apparatus comprising:
a charging coil that generates a magnetic flux due to power supply;
a storage section that stores coil information in association with identification information of a battery module of the charge-target device, the coil information indicating characteristics of a power receiving coil of the charge-target device; and
a charging control section that detects a conductive foreign object from a percentage by which a power supply efficiency during charging of the charge-target device decreases relative to an ideal efficiency of power supply for the charge-target device based on the coil information stored in the storage section.

15. The contactless charging apparatus according to claim 10, wherein the storage section stores in advance the coil information associated with the identification information of the battery module.

16. The contactless charging apparatus according to claim 10, further comprising:
a communication section that obtains the identification information of the battery module and the coil information from the charge-target device, wherein the storage section stores the identification information of the battery module and the coil information obtained by the communication section.

17. (canceled)
